(19) United States
(12) Patent Application Publication
(10) Pub. No.: US 2024/0257025 A1
(43) Pub. Date: Aug. 1, 2024

(54) SALESPERSON EVALUATION DEVICE, SALESPERSON EVALUATION METHOD, AND SALESPERSON EVALUATION PROGRAM

(71) Applicant: VANISH STANDARD CO., LTD., Tokyo (JP)

(72) Inventor: Yasuaki ONOZATO, Tokyo (JP)

(21) Appl. No.: 18/561,120

(22) PCT Filed: Jun. 11, 2021
(86) PCT No.: PCT/JP2021/022385

§ 371 Date: Nov. 15, 2023

(51) Int. Cl. G06Q 10/0639; G06Q 30/0207

(52) U.S. Cl. CPC G06Q 10/06398; G06Q 30/0207

(57) ABSTRACT

A salesperson evaluation device includes an incentive application unit 25 applying incentive set by a predetermined rule to a salesperson who has performed a sales promotion of a product, on the basis of EC sales status information that is information indicating a status relevant to the sales of the product on an EC site of a company operating a physical store and the EC site and is information associated with the salesperson who has performed the sales promotion of the product, and store sales status information indicating a status relevant to the sale of the product at the physical store, in which when the product sold on the EC site is subjected to the sales promotion by the salesperson, the incentive to be applied to the salesperson is calculated by reflecting not only the status relevant to the sales of the product on the EC site but also the status relevant to the sales of the product at the physical store on the predetermined rule, and thus, it is possible to improve sales at the physical store while improving sales on the EC site by increasing a motivation for the salesperson to sell the product on the EC site.

### TECHNICAL FIELD

The present invention relates to a salesperson evaluation device, a salesperson evaluation method, and a salesperson evaluation program, and is particularly preferably used in a system evaluating a salesperson selling a product on the basis of a predetermined rule.

### BACKGROUND ART

In the related art, a system is known in which a motivation for sales is improved by applying an incentive such as a point or a bonus to a salesperson selling a product, on the basis of a sales performance or the like (for example, refer to PTLs 1, 2).

In the system described in PTL 1, the incentive is applied to the salesperson who causes a user to purchase the product by using an EC site. For example, a salesperson code associated with a product code of a recommended product (a product selected by a person in charge of product management) is read out from an order information storage unit, and the incentive (an amount at a predetermined ratio of the order volume of the recommended product, a predetermined amount according to the number of recommended products ordered, or the like) is applied to a salesperson corresponding to the salesperson code.

In a system described in PTL 2, for each of a plurality of periods, a product desired to be intensively sold during the period is designated as a target product, and a sales targets number of the target product is set for a salesperson of each store. Then, a predetermined number of points are applied to the salesperson in accordance with a sales target achievement rate at the end of each period, and a predetermined free gift is applied in accordance with the total number of points gained by the salesperson, after a set of point application target periods are ended.

As described in PTLs 1, 2, an object of applying the incentive according to the sales performance to the salesperson is to motivate the salesperson, improve each sales performance, and eventually improve the sales of the company to which the salesperson belongs. However, in a company selling products on both of an EC site and a physical store, in a case where the salesperson is overzealous in a sales promotion on the EC site (hereinafter, may be referred to as a digital customer service) in order to gain the incentive, there is a possibility that an adverse effect occurs in which a sales task (hereinafter, may be referred to as a real customer service) at the physical store may be neglected, and the sales at the physical store may not increase as intended.
PTL 1: JP2014-182760A
PTL 2: JP2001-22821A

### SUMMARY OF INVENTION

### Technical Problem

The invention has been made in order to solve the problems as described above, and an object thereof is to improve sales at a physical store while improving sales on an EC site by increasing a motivation for a salesperson to sell a product on the EC site.

### Solution to Problem

In order to attain the object described above, in the invention, an incentive set by a predetermined rule is applied to a salesperson who has performed a sales promotion of a product, on the basis of EC sales status information that is information indicating a status relevant to the sales of the product on an EC site of a company operating a physical store and the EC site and is information associated with the salesperson who has performed the sales promotion of the product, and store sales status information that is information indicating a status relevant to the sales of the product at the physical store.

### Advantageous Effects of Invention

According to the invention configured as described above, in a case where the salesperson performs the sales promotion with respect to the product sold on the EC site, the incentive to be applied to the salesperson is set by reflecting not only the status relevant to the sales of the product on the EC site but also the status relevant to the sales of the product at the physical store on the predetermined rule. Accordingly, the salesperson is motivated not only to enthusiastically perform the sales promotion such that more products are sold on the EC site (a digital customer service), but also to act such that more products are also sold at the physical store (a real customer service). Accordingly, according to the invention, it is possible to improve the sales at the physical store while improving the sales on the EC site by increasing the motivation for the salesperson to sell the product on the EC site.

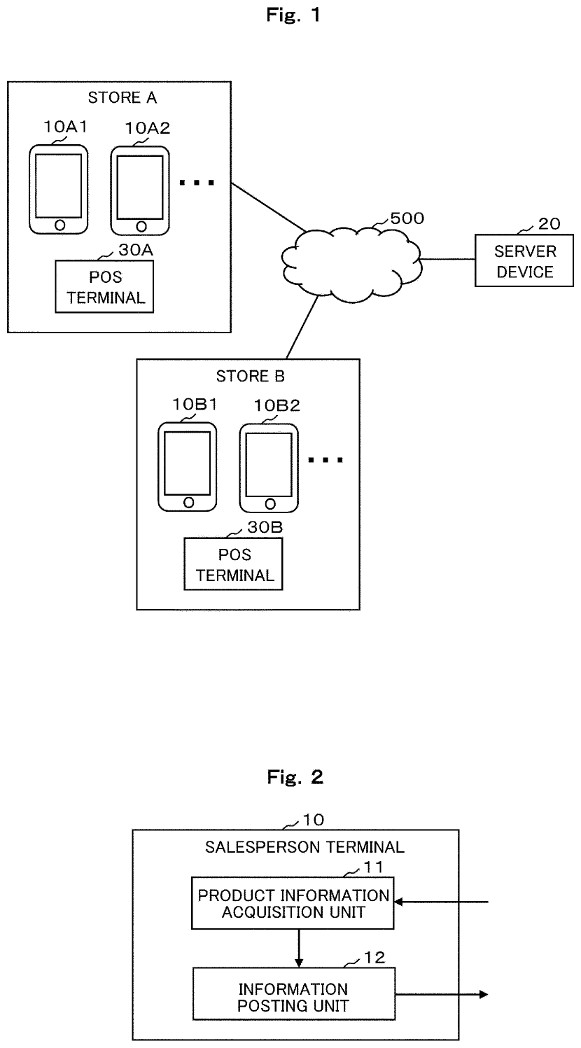

FIG. 1 is a diagram illustrating an overall configuration example of an evaluation system including a salesperson evaluation device according to this embodiment.

FIG. 2 is a block diagram illustrating a functional configuration example of a salesperson terminal according to this embodiment.

FIG. 3 is a block diagram illustrating a functional configuration example of a server device according to this embodiment.

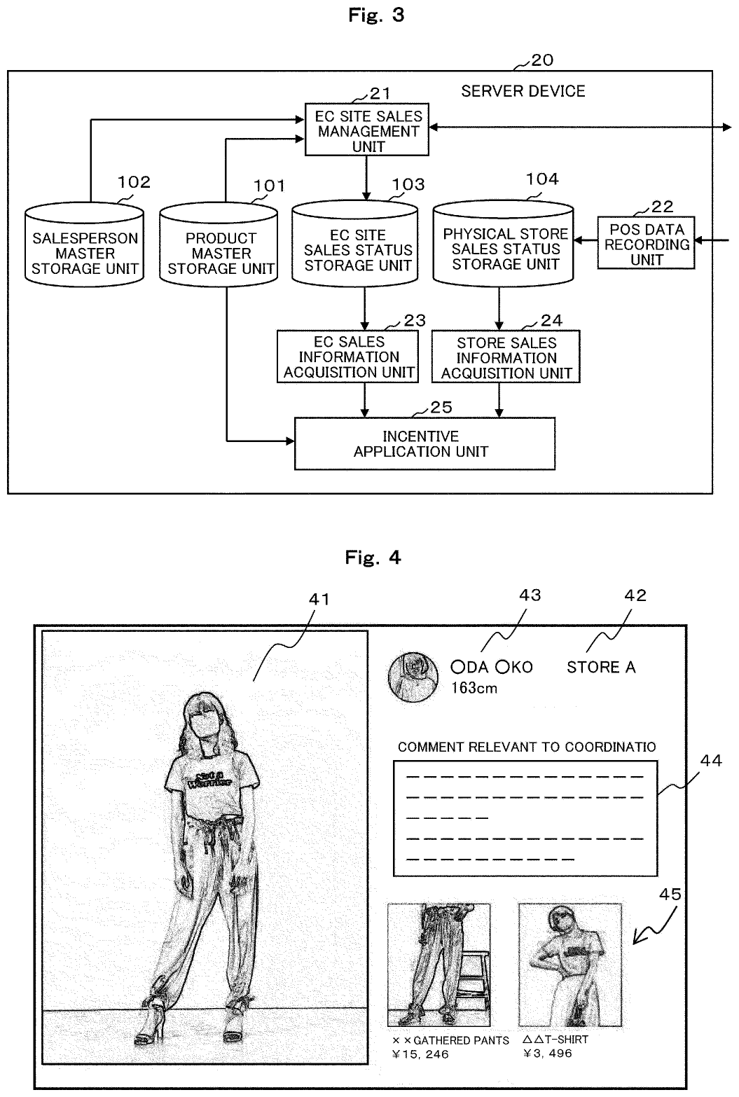

FIG. 4 is a diagram illustrating an example of a coordination posting page.

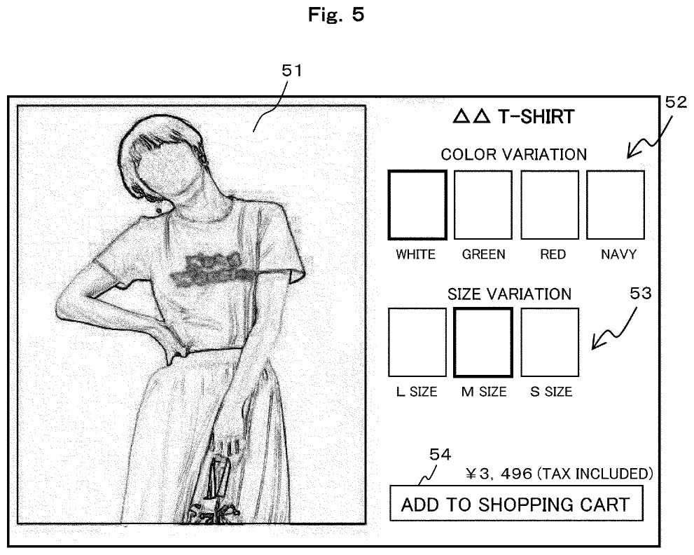

FIG. 5 is a diagram illustrating an example of a product detailed page.

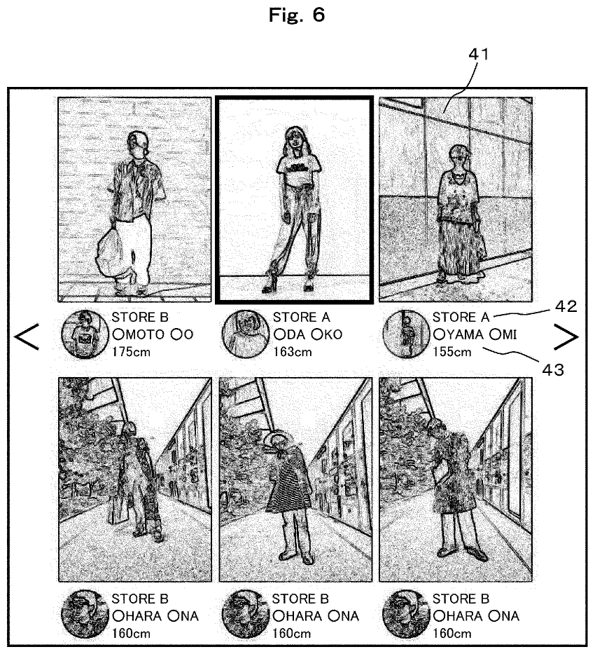

FIG. 6 is a diagram illustrating an example of a posting list page.

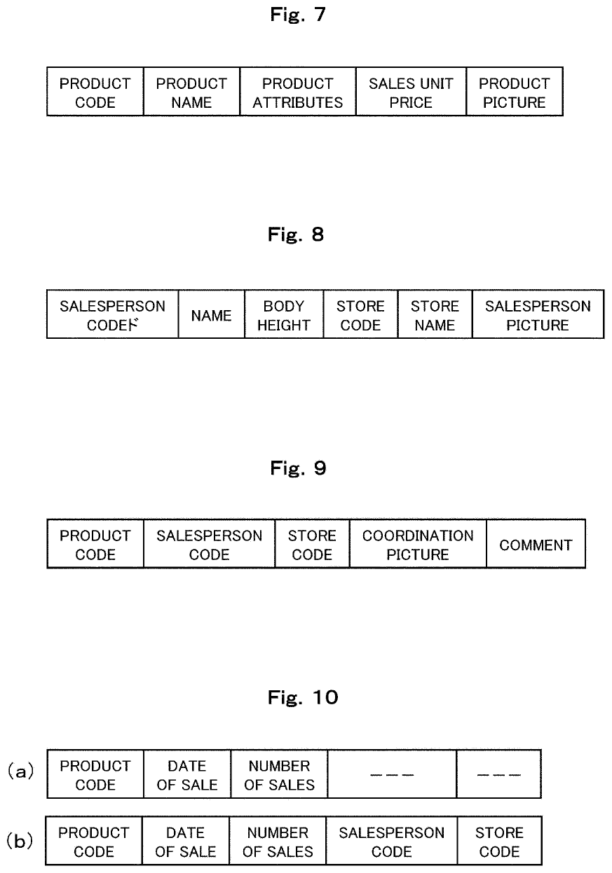

FIG. 7 is a diagram illustrating an example of product master information stored in a product master storage unit.

FIG. 8 is a diagram illustrating an example of salesperson master information stored in a salesperson master storage unit.

FIG. 9 is a diagram illustrating an example of posting-related information (sales promotion management information) stored in an EC site sales status storage unit.

FIG. 10 is a diagram illustrating an example of sales status information (sales performance information) stored in the EC site sales status storage unit.

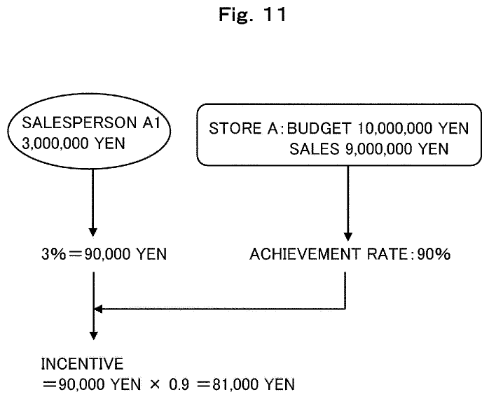

FIG. 11 is a schematic view for illustrating an example of processing details of an incentive application unit.

### DESCRIPTION OF EMBODIMENTS

Hereinafter, one embodiment of the invention will be described on the basis of the drawings. FIG. 1 is a diagram illustrating an overall configuration example of an evaluation system including a salesperson evaluation device according to this embodiment. As illustrated in FIG. 1, the evaluation system of this embodiment includes salesperson terminals 10A1, 10A2, . . . , 10B1, 10B2, . . . used by a plurality of salespersons belonging to stores A and B, a server device 20, and POS terminals 30A, 30B used by a plurality of stores A and B. The server device 20 is connected from each of the salesperson terminals 10A1, 10A2, . . . 10B1, 10B2, . . . through a communication network 500 such as the internet and a mobile telephone network. The server device 20 is connected from each of the POS terminals 30A, 30B through a communication network 500.

The salesperson terminals 10A1, 10A2, . . . are terminals used by a plurality of salespersons A1, A2, . . . belonging to the store A. In addition, the salesperson terminals 10B1, 10B2, . . . are terminals used by a plurality of salespersons B1, B2, . . . belonging to the store B. Here, the stores A and B are physical stores existing at different spots. In the following description, when each of the salesperson terminals 10A1, 10A2, ., 10B1, 10B2, . is not particularly distinguished, the salesperson terminals will be simply referred to as a salesperson terminal 10. Note that, here, two stores A and B are illustrated, but the number of stores is not limited thereto. There may be one physical store, or there may be three or more physical stores.

The salesperson terminal 10 is a terminal used by the salesperson selling a product that is a sales target of a company (hereinafter, referred to as a sales target product), and for example, is a smart phone, a tablet terminal, a personal computer, and the like. In this embodiment, the company is a company operating both of physical stores and EC sites. The sales target product is a product sold through the EC site and the physical stores. The product sold through the EC site may be identical to or different from a product sold at the physical store. Hereinafter, it will be described that a fashion-related product is sold, as an example of the product.

In the salesperson terminal 10, a support application (hereinafter, referred to as a sales support app) that enables the salesperson to implement a sales promotion (a digital customer service) through the EC site regarding the sales target product is installed. The salesperson implements the sales promotion of the sales target product by using the function of the sales support app. Examples of an implementation function of the sales promotion provided by the sales support app include a fashion coordination posting function. This is a function (the details thereof will be described below) of associating product information with a coordination picture captured by the salesperson to be posted to the EC site. In the following description, the sales promotion of the sales target product is a digital customer service using a coordination posting function of the sales support app.

POS terminals 30A and 30B are terminals for managing the sales of the sales target product sold at the physical stores of the stores A and B, and includes a cash register, a bar-code reader, a card reader, a POS printer, and other peripheral devices. The POS terminals 30A and 30B manage only sales relevant to the product sold at the physical store (information indicating a status relevant to the sales of the product at the physical store), and do not manage sales relevant to the product sold through the EC site (information indicating a status relevant to the sales of the product on the EC site). The sales relevant to the product sold through the EC site is managed by the server device 20.

The server device 20 performs processing relevant to the sales of the sales target product on the EC site and performs processing relevant to the evaluation of the salesperson selling the sales target product, and has the functions of a sales management device and a salesperson evaluation device. Here, the function of the sales management device and the function of the salesperson evaluation device are provided in one server device 20, but such functions may be divided into two or more servers.

The processing relevant to the sales, which is the function of the sales management device, is each processing piece required to sell the sales target product through the EC site, and includes processing such as the posting of the product information, the registration of a product designated by a consumer to a shopping cart, and the payment of the product registered to the shopping cart. The posting of the product information to the EC site includes processing of posting the sales target product that is posted by the salesperson using a coordination posting function of the sales support app.

The processing relevant to the evaluation, which is the function of the salesperson evaluation device, includes processing of evaluating the salesperson who has performed the sales promotion on the EC site, on the basis of the sales status of the sales target product (including a sales status on the EC site and a sales status at the physical store). As an assumption for performing the evaluation, the server device 20 executes each processing piece required to aggregate the sales status of the sales target product sold through the EC site, and acquires the information indicating the sales status of the sales target product sold at the physical store from the POS terminals 30A and 30B.

FIG. 2 is a block diagram illustrating a functional configuration example of the salesperson terminal 10 according to this embodiment. As illustrated in FIG. 2, the salesperson terminal 10 of this embodiment includes a product information acquisition unit 11 and an information posting unit 12, as a functional configuration. Such functional blocks 11 and 12 actually include CPU, RAM, ROM, or the like of a computer, and are attained by operating a program of the sales support app stored in a storage medium such as RAM, ROM, a hard disk, or a semiconductor memory.

The product information acquisition unit 11 acquires the product information indicating a product included in target coordination to be posted by the salesperson (a product subjected to the sales promotion) from product master information managed as information of the sales target product in the server device 20. Here, the product information to be acquired may be information that is capable of specifying the product. For example, a product code uniquely allocated to the product can be used.

The information posting unit 12 posts information relevant to the sales promotion of the sales target product (hereinafter, referred to as sales promotion information) to the EC site of the company. The sales promotion information, for example, is related information such as the coordination picture captured by the salesperson or a comment created by the salesperson in association with the coordination picture. Here, the information posting unit 12 posts the sales promotion information to the EC site by associating the product information indicating the product subjected to the sales promotion (the product information acquired by the product information acquisition unit 11), salesperson information indicating the salesperson performing the sales promotion, and store information indicating the store to which the salesperson performing the sales promotion belongs with the sales promotion information.

In the following description, posting the sales promotion information (coordination information described below is synonymous with this term) indicates that the product information, the salesperson information, and the store information, which are associated with the sales promotion information, are also transmitted to the server device 20 together with the sales promotion information. In addition, in the following description, the sales promotion information (the coordination information), the product information, the salesperson information, and the store information, which are transmitted to the server device 20 from the salesperson terminal 10, will be collectively referred to as posting-related information.

The salesperson information may be information that is capable of specifying the salesperson. For example, a salesperson code uniquely allocated to the salesperson can be used. The store information may be information that is capable of specifying the store. For example, a store code uniquely allocated to the store can be used. For example, the salesperson code and the store code are registered in advance in the sales support app used by the salesperson, and the salesperson code and the store code, which are registered in advance, and the product code acquired by the product information acquisition unit 11 are associated with the sales promotion information created by the salesperson.

The EC site to which the sales promotion information is posted is a website that is operated by the company to sell the sales target product. The EC site includes a coordination posting page displaying the coordination information (the sales promotion information including the related information such as the coordination picture or the comment) posted from the salesperson, in addition to a product catalog page displaying a plurality of products as a list, a product detailed page displaying detailed information of each of the products, and the like.

FIG. 4 is a diagram illustrating an example of the coordination posting page on which the coordination information posted from a certain salesperson is displayed. As illustrated in FIG. 4, a coordination picture 41, a name 42 of the store to which the salesperson belongs, salesperson related information 43, a comment 44 of the salesperson relevant to the coordination, and product-related information 45 of each of the products included in the coordination picture 41 are posted to the coordination posting page. The salesperson related information 43, for example, includes information such as the picture, the name, or the body height of the salesperson. The product-related information 45, for example, includes information such as the picture, the product name, or the price of the product. The coordination posting page is generated in the server device 20, on the basis of the posting-related information transmitted to the server device 20 from the salesperson terminal 10, and the product master information and the salesperson master information retained by the server device 20.

In the example of FIG. 4, the coordination picture 41 in which a product X of gthered pants and a product Y of a T-shirt are combined is posted, and information pieces relevant to two products X and Y are each posted to the product-related information 45. Here, for example, in the case of clicking the picture of the product X or the product Y, a transition to the product detailed page of the product X or the product Y is performed.

FIG. 5 is a diagram illustrating an example of the product detailed page. As illustrated in FIG. 5, the product detailed page includes a product picture 51, a color selection field 52, a size selection field 53, and a shopping cart button 54. The consumer is capable of registering the designated product to the shopping cart by selecting a desired color and a desired size and manipulating the shopping cart button 54.

FIG. 6 is a diagram illustrating an example of the posting list page. A plurality of salespersons each perform one or more coordination postings, and thus, a plurality of coordination information pieces are accumulated in the server device 20. The posting list page illustrated in FIG. 6 is a page for displaying the outline of a plurality of coordination postings as a list. As illustrated in FIG. 6, for each of the coordination postings, the coordination picture 41, the name 42 of the store to which the salesperson belongs, and the salesperson related information 43 are posted to the posting list page. In the case of clicking any of the coordination pictures 41, a transition to the coordination posting page illustrated in FIG. 4 is performed.

FIG. 3 is a block diagram illustrating a functional configuration example of the server device 20 according to this embodiment. As illustrated in FIG. 3, the server device 20 of this embodiment includes a EC site sales management unit 21, a POS data recording unit 22, an EC sales information acquisition unit 23, a store sales information acquisition unit 24, and an incentive application unit 25, as a functional configuration. In addition, the server device 20 includes a product master storage unit 101, a salesperson master storage unit 102 an EC site sales status storage unit 103, and a physical store sales status storage unit 104 as a storage medium.

Each of the functional blocks 21 to 25 described above can be configured by any of hardware, a digital signal processor (DSP), and software. For example, in a case where each of the functional blocks is configured by the software, each of the functional blocks 21 to 25 described above actually includes CPU, RAM, ROM, or the like of a computer, and is attained by operating a program (including a salesperson evaluation program) stored in a storage medium such as RAM, ROM, a hard disk, or a semiconductor memory.

The product master storage unit 101 stores the product master information relevant to a plurality of sales target products. FIG. 7 is a diagram illustrating an example of the product master information stored in the product master storage unit 101. As illustrated in FIG. 7, the product master storage unit 101 stores information such as the product code, the product name, product attributes, a sales unit price, and the product picture (or an address indicating a storage site thereof), for each of the plurality of sales target products. The product attributes are information for specifying the attributes in a case where the same products have different attributes. For example, the product attributes are the color, the size, or the like of the product. Note that, the information described here is an example, and the product master information may include information other than the above information.

The salesperson master storage unit 102 stores the salesperson master information relevant to a plurality of salespersons. FIG. 8 is a diagram illustrating an example of the salesperson master information stored in the salesperson master storage unit 102. As illustrated in FIG. 8, the salesperson master storage unit 102 stores information such as the salesperson code, the name, the body height, the store code, the store name, and the salesperson member (or an address indicating a storage site thereof), for each of the plurality of salespersons. Note that, the information described here is an example, and the salesperson master information may include information other than the above information.

The EC site sales management unit 21 executes various processing pieces that are required when selling the sales target product on the EC site. The EC site sales management unit 21 also executes processing relevant to information management of managing the sales status information, the salesperson information, and the store information in association with each other. For example, the EC site sales management unit 21 executes processing relevant to the generation and the provision of the product catalog page (not illustrated) and processing relevant to the generation and provision of the product detailed page illustrated in FIG. 5. Here, the EC site sales management unit 21 generates the product catalog page and the product detailed page by using the product master information stored in the product master storage unit 101. The product detailed page is generated in accordance with either the transition from the product catalog page or the transition from the coordination posting page illustrated in FIG. 4.

In addition, the EC site sales management unit 21 also executes various processing pieces relevant to the implementation (the coordination posting) of the sales promotion of the sales target product. That is, the EC site sales management unit 21 extracts the product information of the product desired by the salesperson from the product master information stored in the product master storage unit 101 and provides the extracted product information, in accordance with a request from the product information acquisition unit 11 of the salesperson terminal 10. In addition, the EC site sales management unit 21 receives the posting-related information transmitted by the information posting unit 12 of the salesperson terminal 10, and sequentially records the posting-related information in the EC site sales status storage unit 103.

FIG. 9 is a diagram illustrating an example of the posting-related information stored in the EC site sales status storage unit 103. FIG. 9 illustrates one record that stores the posting-related information, and records are added one by one each time when the EC site sales management unit 21 receives the coordination information from the salesperson terminal 10.

As illustrated in FIG. 9, the EC site sales status storage unit 103 stores the posting-related information in which the product code, the salesperson code, the store code, the coordination picture, and the comment are associated with each other, in one record. Regarding to the product code, a plurality of product codes are included corresponding to a plurality of products included in the coordination picture. The coordination picture and the comment may be stored in a site different from the record, and an address indicating the storage site may be stored in the record.

The posting-related information illustrated in FIG. 9 is used as sales promotion management information for managing the product information indicating the product, the salesperson information indicating the salesperson, and the store information indicating the store to which the salesperson belongs in association with each other, for the product subjected to the sales promotion by the salesperson. Note that, the sales promotion management information may be stored separately from the posting-related information. In this case, a posting code for uniquely specifying each of the posting-related information pieces is issued, and the sales promotion management information may be configured by associating the posting code with the product code, the salesperson code, and the store code.

In addition, the EC site sales management unit 21 also executes processing relevant to the generation and the provision of the posting list page illustrated in FIG. 6. Here, the EC site sales management unit 21 generates the posting list page by using the coordination picture, the salesperson code, and the store code in the posting-related information of FIG. 9 that is stored in the EC site sales status storage unit 103, and the salesperson master information stored in the salesperson master storage unit 102.

In addition, the EC site sales management unit 21 also executes processing relevant to the generation and the provision of the coordination posting page illustrated in FIG. 4. Here, the EC site sales management unit 21 generates the coordination posting page by using the posting-related information of FIG. 9 that is stored in the EC site sales status storage unit 103, the product master information stored in the product master storage unit 101, and the salesperson master information stored in the salesperson master storage unit 102.

Further, the EC site sales management unit 21 also executes processing relevant to the registration of the product designated by the consumer to the shopping cart, processing relevant to the payment of the product registered to the shopping cart, or the like. That is, the EC site sales management unit 21 also executes processing relevant to the purchase of the sales target product that is performed through the access to an EC site from a consumer terminal, which is not illustrated. The consumer is capable of performing a set of procedures for browsing the plurality of sales target products on the EC site, and selecting and purchasing a desired sales target product from the plurality of sales target products, and processing relevant to the set of procedures is executed by the EC site sales management unit 21.

The EC site sales management unit 21 records sales status information indicating a status relevant to the sales of the product through the EC site in the EC site sales status storage unit 103. For example, in a case where the consumer purchases the sales target product through the EC site, the EC site sales management unit 21 records information indicating when and how many sales target products are sold, that is, information indicating the sales performance of the product in the EC site sales status storage unit 103, as the sales status information.

Here, in a case where the product is registered to the shopping cart in accordance with the transition to the product detailed page illustrated in FIG. 5 from the coordination posting page illustrated in FIG. 4, the salesperson code and the store code of the salesperson, which are used when generating the coordination posting page, are associated with the product code of the product. In this case, the EC site sales management unit 21 records the sales status information including the product code, the date of sale, and the number of sales of the sold product in the EC site sales status storage unit 103, in association with the salesperson code and the store code of the salesperson who has posted the coordination. That is, the EC site sales management unit 21 records the sales status information relevant to the product subjected to the sales promotion by the salesperson (sales performance information) among the target products sold on the EC site in the EC site sales status storage unit 103, in association with the salesperson code and the store code included in the posting-related information (the sales promotion management information) of FIG. 9.

On the other hand, in a case where the product is registered to the shopping cart in accordance with the transition to the product detailed page illustrated in FIG. 5 from the product catalog page which is not illustrated, the salesperson code and the store code are not associated with the product code of the product. In this case, the EC site sales management unit 21 records the product code, the date of sale, and the number of sales of the sold product in the EC site sales status storage unit 103, as the sales status information, but does not perform the association with the salesperson code and the store code.

FIG. 10 is a diagram illustrating an example of the sales status information (the sales performance information) stored in the EC site sales status storage unit 103. FIG. 10 illustrates one record that stores the sales status information, and records are added one by one each time when the purchase of the sales target product by the consumer is detected by the EC site sales management unit 21.

As illustrated in FIG. 10 (a), the EC site sales status storage unit 103 stores the product code of the sold product in accordance with the transition to the product detailed page of FIG. 5 from the product catalog page, the date of sale and the number of sales in one record, as the sales status information.

In addition, as illustrated in FIG. 10 (b), the EC site sales status storage unit 103 stores the product code of the sold product in accordance with the transition to the product detailed page of FIG. 5 from the coordination posting page, the date of sale and the number of sales in one record, as the sales status information, and stores the salesperson code and the store code in the same record in association with the sales status information. The record illustrated in FIG. 10 (b) can be referred to as information in which the sales status information (the product code, the date of sale, and the number of sales) indicating the status (the sales performance) relevant to the sales of the product on the EC site of the company, the salesperson information (the salesperson code) indicating the salesperson who has performed the sales promotion of the product, and the store information (the store code) indicating the store to which the salesperson belongs are associated with each other.

The POS data recording unit 22 acquires POS data from the POS terminals 30A and 30B of the stores A and B, respectively, and stores the POS data in the physical store sales status storage unit 104. It is sufficient that the POS data acquired by the POS data recording unit 22 includes the information indicating the status relevant to the sales of the product at the physical stores of the stores A and B (the sales performance of the product at the physical store), and it is not essential to acquire all the information managed by the POS terminals 30A and 30B. The information indicating the sales performance is not necessarily information that is capable of specifying each of the sold products or each of the salespersons who has performed a real customer service, and for example, may be the total sales information in the store unit.

In addition, it is sufficient that the POS data acquired by the POS data recording unit 22 is information from which the sales performance of the physical store per unit period is figured out. The unit period is an evaluation target period (for example, one month) at a predetermined time interval during which the incentive application unit 25 executes the processing. For example, at the beginning of every month, the POS data recording unit 22 acquires the POS data for the last month from the POS terminals 30A and 30B and stores the POS data in the physical store sales status storage unit 104. The POS data to be acquired may be information indicating a daily sales performance within the unit period, or may be information indicating a monthly sales performance obtained by aggregating the daily sales performance for the unit period. In a case where the POS data is the information indicating the daily sales performance, the POS data recording unit 22 may acquire the POS data from the POS terminals 30A and 30B every day, and may store the POS data in the physical store sales status storage unit 104.

The EC sales information acquisition unit 23 acquires the information indicating the status relevant to the sales of the product on the EC site of the company, which is information associated with the salesperson who has performed the sales promotion of the product (hereinafter, referred to as EC sales status information) from the EC site sales status storage unit 103. For example, at the beginning of every month, the EC sales information acquisition unit 23 acquires the EC sales status information relevant to each of the salespersons for the last month from the EC site sales status storage unit 103. Here, among the records of the sales status information for the last month, which are stored in the EC site sales status storage unit 103, the EC sales information acquisition unit 23 acquires one or more records in which the salesperson code is recorded as illustrated in FIG. 10 (b), as the EC sales status information.

The store sales information acquisition unit 24 acquires the information indicating the status relevant to the sales of the product at the physical store of the company (hereinafter, referred to as store sales status information) from the physical store sales status storage unit 104. For example, at the beginning of every month, the store sales information acquisition unit 24 acquires the store sales status information relevant to each of the stores A and B for the last month from the physical store sales status storage unit 104.

The incentive application unit 25 applies an incentive set by a predetermined rule to the salesperson who has performed the sales promotion of the product, on the basis of the EC sales status information acquired by the EC sales information acquisition unit 23 and the store sales status information acquired by the store sales information acquisition unit 24. For example, the incentive application unit 25 calculates an evaluation value by using a function in which an individual sales performance value in an individual unit that is specified for each of the salespersons on the basis of the EC sales status information, and a store sales performance value in a store unit that is specified for each of the stores on the basis of the store sales status information are set to an explanatory variable, and the evaluation value indicating the incentive is set to an object variable.

Here, the incentive application unit 25 is capable of performing processing of calculating an amount as the evaluation value, and setting the amount to be supplied as a compensation or a bonus of the salesperson. Alternatively, the incentive application unit 25 may perform processing of calculating a point as the evaluation value, and applying the point to the salesperson. Here, the point to be applied, for example, can be an appraisal point for personnel evaluation. Alternatively, the point can be a point having an economic value that can be used in the actual commercial transaction.

The individual sales performance value in the individual unit relevant to the salesperson who has performed the sales promotion of the product, for example, can be obtained by calculating the total sales of the product sold on the basis of the coordination posting of the salesperson per unit period for each of the salespersons. The total sales of the product sold on the basis of the coordination posting of a certain salesperson A1 can be calculated as follows. That is, among the records of the EC sales status information for the last month, which are acquired from the EC site sales status storage unit 103 by the EC sales information acquisition unit 23 (FIG. 10 (b)), one or more records in which the salesperson code of the salesperson A1 is recorded is extracted. Then, the sales unit price corresponding to the product code included in each of the extracted records is checked with the product master information, and the sales unit price is multiplied by the number of sales, and thus, the sales are obtained for each of the records. Then, by summing up the sales obtained for each of the records, the total sales of the salesperson A1 per one month is calculated.

In addition, the store sales performance value in the store unit can be obtained on the basis of the store sales status information acquired from the physical store sales status storage unit 104 by the store sales information acquisition unit 24. When obtaining the evaluation value of a certain salesperson A1, the store sales status information of the store A indicated by the store code included in the record of the EC sales status information is used. Here, in a case where the information indicating the monthly sales performance at each of the stores (the total sales per one month) is stored in the physical store sales status storage unit 104, the information can be directly used as the store sales performance value in the store unit. On the other hand, in a case where the information indicating the daily sales performance at each of the stores (the total daily sales) is stored in the physical store sales status storage unit 104, the total sales is set to the store sales performance value in the store unit by summing up the daily sales in a monthly unit.

The function in which the individual sales performance value in the individual unit and the store sales performance value in the store unit, which are specified as described above, are set to the explanatory variable, and the evaluation value indicating the incentive is set to the object variable can be designed in any manner. For example, the function can be a function that includes arithmetic operation of calculating an achievement rate with respect to a store budget (a target sales) set for the sales of the product at the physical store on the basis of the store sales performance value, and calculates the evaluation value with respect to the salesperson by reflecting the achievement rate with respect to the store budget on the individual sales performance value.

As an example, the incentive application unit 25 calculates a provisional evaluation value from the sales performance value (the total monthly individual sales) specified for each of the salespersons who has performed the sales promotion of the product, on the basis of the EC sales status information, calculates a weight value on the basis of the store sales status information in the store unit, and applies the weight value to the provisional evaluation value to calculate the evaluation value indicating the incentive. Here, the incentive application unit 25 calculates the achievement rate with respect to the store budget, on the basis of the store sales performance value in the store unit, and calculates the weight value on the basis of the achievement rate.

FIG. 11 is a schematic view for illustrating an example of the processing details of the incentive application unit 25. Here, a calculation example of the incentive to be applied to the salesperson A1 belonging to the store A is illustrated. In addition, here, an example is illustrated in which an amount is calculated as the evaluation value indicating the incentive.

As illustrated in FIG. 11, the total monthly individual sales relevant to one or more sales target products sold through the coordination posting page of the salesperson A1 of the store A is assumed to 3,000,000 yen. In this case, the incentive application unit 25, for example, calculates an amount (90,000 yen) obtained by multiplying the total monthly individual sales relevant to the salesperson A1 by a predetermined ratio (for example, 3%), as the provisional evaluation value.

In addition, as illustrated in FIG. 11, in the store A, 10,000,000 yen is set as the monthly budget (the target sales), and the total monthly store sales relevant to one or more sales target products sold at the physical store is assumed to 9,000,000 yen. In this case, the incentive application unit 25 calculates the achievement rate of the store total sales with respect to the store budget as 90%, and sets the weight value to 0.9 on the basis of the achievement rate. Then, an amount (81,000 yen) obtained by multiplying the weight value by the provisional evaluation value of 90,000 yen is calculated as the final evaluation value.

As described above in detail, in this embodiment, on the basis of the EC sales status information indicating the sales performance on the EC site for each of the salespersons who has performed the sales promotion (the digital customer service such as the coordination posting) and the store sales status information indicating the sales performance at the physical store for each of the stores, the incentive set by the predetermined rule to which both of the EC sales status information and the store sales status information are added is applied to the salesperson who has performed the sales promotion of the product on the EC site.

According to this embodiment configured as described above, in a case where the salesperson performs the sales promotion with respect to the product sold on the EC site, the incentive to be applied to the salesperson is set by reflecting not only the status relevant to the sales of the product on the EC site but also the status relevant to the sales of the product at the physical store on the predetermined rule. For example, as illustrated in FIG. 11, not only the total individual sales of the product sold through the coordination posting (the digital customer service) by the salesperson but also the budget achievement rate of the total store sales of the product sold through the real customer service at the physical store are reflected on the calculation of the incentive to be applied to the salesperson.

Accordingly, the salesperson is motivated not only to enthusiastically perform the sales promotion such that more products are sold on the EC site (the digital customer service), but also to act such that more products are also sold at the physical store (the real customer service). Accordingly, according to this embodiment, it is possible to improve the sales at the physical store while improving the sales on the EC site by increasing the motivation for the salesperson to sell the product on the EC site.

Note that, in this embodiment, an example has been described in which the incentive with respect to the salesperson is calculated on the basis of the sales performance information by using the sales performance information indicating the sales performance of the product on the EC site as the EC sales status information, but the invention is not limited thereto. For example, the incentive may be calculated by using at least one of the sales performance information on the EC site, information indicating the implementation status of the sales promotion performed by the salesperson (sales promotion status information), and information indicating the reaction status of the consumer with respect to the sales promotion (sales promotion reaction information).

Here, the incentive application unit 25, for example, is capable of calculating the incentive (for example, calculating the provisional evaluation value) by using the sales performance information in (A) described below, the sales promotion status information in (B) described below, and the sales promotion reaction information in (C) described below.

(A) Performance of Salesperson: the total sales of sales promotion target product sold by the salesperson through the coordination post during a unit period

(B) Number of Contents Postings: the total number of coordination information pieces posted by the coordination posting

(C) Number of PVs: the total number of PVs of the coordination posting page

In addition, in the embodiment described above, an example has been described in which the sales promotion performed by the salesperson is the coordination posting on the EC site of the company, but the invention is not limited thereto. For example, the sales promotion may be processing of posting a comment relevant to the point or the feature of the sales target product that is seen from the salesperson and is easily grasped on the EC site, processing of posting the sales target product (including the coordination), the comment relevant thereto, and the like on the personal SNS (such as Instagram, Facebook, and LINE, which are the registered trademark) of the salesperson, or the like.

In addition, in the embodiment described above, an example has been described in which the sales promotion by the salesperson is performed on the EC site of the company, but the invention is not limited thereto. For example, a target website on which the sales promotion is performed may be a website for sales promotion that is created by the salesperson oneself.

In addition, in the embodiment described above, various information pieces are illustrated in FIGS. 7 to 10, but such drawings illustrate an example of a method for storing various information pieces in the EC site sales status storage unit 103, and the invention is not limited thereto. In conclusion, various information pieces may be stored in a form in which the association between the sales status information, the salesperson information, and the store information can be grasped.

In addition, in the embodiment described above, a case in which the sales target product is the fashion-related product has been described as an example, but the sales target product is not limited thereto. Any product can be the target. In addition, the product to be used may be either a product as an object or a product as a service.

In addition, the embodiment described above is merely an example of specification for implementing the invention, and the technical scope of the invention should not be construed to be restrictive thereby. That is, the invention can be implemented in various forms without departing from the gist or the main features thereof.

### REFERENCE SIGNS LIST

10: salesperson terminal
11: product information acquisition unit
12: information posting unit
20: server device (salesperson evaluation device)
21: sales management unit
22: POS data recording unit
23: EC sales information acquisition unit
24: store sales information acquisition unit
25: incentive application unit
101: product master storage unit
102: salesperson master storage unit
103: EC site sales status storage unit
104: physical store sales status storage unit

1. A salesperson evaluation device, characterized by comprising:
an EC sales information acquisition unit acquiring EC sales status information that is information indicating a status relevant to sales of a product on an EC site, the product being selected by a salesperson as a target of a sales promotion from sales target products of a company operating a physical store and the EC site, and is information associated with the salesperson who has performed the sales promotion of the selected product;
a store sales information acquisition unit acquiring store sales status information that is information indicating a status relevant to the sales of the product at the physical store of the company; and
an incentive application unit applying an incentive set by a predetermined rule, on which a status relevant to the sales of the product subjected to the sales promotion on the EC site and a status relevant to the sales of the product at the physical store are reflected, to the salesperson who has performed the sales promotion of the selected product, on the basis of the EC sales status information acquired by the EC sales information acquisition unit and the store sales status information acquired by the store sales information acquisition unit.

2. The salesperson evaluation device according to claim 1, characterized in that
the incentive application unit calculates an evaluation value indicating the incentive by using a function in which an individual sales performance value in an individual unit that is specified for each of the salespersons who has performed the sales promotion of the product on the basis of the EC sales status information, and a store sales performance value in a store unit that is specified on the basis of the store sales status information are set to an explanatory variable, and the evaluation value is set to an object variable.

3. The salesperson evaluation device according to claim 2, characterized in that
the function is a function that includes arithmetic operation of calculating an achievement rate with respect to a store budget set for the sales of the product at the physical store on the basis of the store sales performance value, and calculates the evaluation value with respect to the salesperson by reflecting the achievement rate with respect to the store budget on the individual sales performance value.

4. The salesperson evaluation device according to claim 1, characterized in that
the incentive application unit calculates a provisional evaluation value from a sales performance value specified for each of the salespersons who has performed the sales promotion of the product on the basis of the EC sales status information, and calculates an evaluation value indicating the incentive by calculating a weight value on the basis of the store sales status information and applying the weight value to the provisional evaluation value.

5. The salesperson evaluation device according to claim 4, characterized in that
the incentive application unit calculates an achievement rate with respect to a budget set for the sales of the product at the physical store, on the basis of the store sales performance value in the store unit that is specified on the basis of the store sales status information, and calculates the weight value on the basis of the achievement rate.

6. A salesperson evaluation method, characterized by comprising:
a step of allowing an EC sales information acquisition unit of a computer to acquire EC sales status information that is information indicating a status relevant to sales of a product on an EC site, the product being selected by a salesperson as a target of a sales promotion from sales target products of a company operating a physical store and the EC site, and is information associated with the salesperson who has performed the sales promotion of the selected product;
a step of allowing a store sales information acquisition unit of the computer to acquire store sales status information that is information indicating a status relevant to the sales of the product at the physical store of the company; and
a step of allowing an incentive application unit of the computer to apply an incentive set by a predetermined rule, on which a status relevant to the sales of the product subjected to the sales promotion on the EC site and a status relevant to the sales of the product at the physical store are reflected, to the salesperson who has performed the sales promotion of the selected product, on the basis of the EC sales status information acquired by the EC sales information acquisition unit and the store sales status information acquired by the store sales information acquisition unit.

7. A salesperson evaluation program for allowing a computer to function as:
EC sales information acquisition means acquiring EC sales status information that is information indicating a status relevant to sales of a product on an EC site, the product being selected by a salesperson as a target of a sales promotion from sales target products of a company operating a physical store and the EC site, and is information associated with the salesperson who has performed the sales promotion of the selected product;
store sales information acquisition means acquiring store sales status information that is information indicating a status relevant to the sales of the product at the physical store of the company; and
incentive application means applying an incentive set by a predetermined rule, on which a status relevant to the sales of the product subjected to the sales promotion on the EC site and a status relevant to the sales of the product at the physical store are reflected, to the salesperson who has performed the sales promotion of the selected product, on the basis of the EC sales status information acquired by the EC sales information acquisition means and the store sales status information acquired by the store sales information acquisition means.
